(19) United States
(12) Patent Application Publication
(10) Pub. No.: US 2010/0185414 A1
(43) Pub. Date: Jul. 22, 2010

(54) ABNORMALITY DETECTION METHOD AND ABNORMALITY DETECTION SYSTEM FOR OPERATING BODY

(75) Inventor: Satoshi Yamamoto, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Cable,Ltd.

(21) Appl. No.: 12/540,520

(22) Filed: Aug. 13, 2009

(30) Foreign Application Priority Data
Jan. 16, 2009 (JP) 2009-007958

(51) Int. Cl. G06F 15/00

(52) U.S. Cl. 702/183

(57) ABSTRACT

A method of detecting an abnormality in an operating body, according to the present invention, comprises steps of: continuously collecting data about the operating body; detecting events for the operating body; extracting part of the data as target data, the part of the data being collected in a predetermined period delimited by times at which the events are detected; preparing comparison data in advance for abnormality detection; comparing the target data with the comparison data to obtain a comparison result; and detecting an abnormality in the operating body from the comparison result.

### CLAIM OF PRIORITY

The present application claims priority from Japanese patent application serial no. 2009-007958 filed on Jan. 16, 2009, the content of which is hereby incorporated by reference into this application.

### BACKGROUND OF THE INVENTION

1. Field of the Invention

The present invention relates to an abnormality detection method and abnormality detection system, particularly to an abnormality detection method and abnormality detection system for an operating body in which the degrees of abnormality or monitoring signals of the operating body are fluctuated by external effects.

2. Description of Related Art

First of all, in this specification, moving bodies, such as automobiles and trains, and manufacturing apparatuses used to perform various types of processing for raw materials, such as wire twisting, extrusion, and rolling, are collectively referred to as operating bodies. Operating bodies are preferably designed so that they can withstand continuous operation for a long period of time. When, however, an operating body is placed in long-time continuous operation or members in individual sections of the operating part are deteriorated by disturbance, the operating body may stop operating or may not perform predetermined operations. Other possible problems involved are that safety is not assured and failures are found in the products. It is desirable to detect abnormality in the operating body and output an alarm or partially or completely stop the operating body before a problem occurs.

In abnormality detection of an operating body, some kinds of monitoring signals must be pulled out. However, the operating body is operating through various operating states, so these monitoring signals often change according to these operating states. Accordingly, to improve abnormality detection precision, it is necessary to eliminate effects due to changes caused by the operation states so that abnormality detection can be performed on the basis of the monitoring signals.

In a method proposed to eliminate the changes caused by operating states, for example, sampling averages and sampling variance in normal operations, data in abnormal operations, and data during monitoring are used, instead of detecting abnormalities according to the level and amplitude of the monitoring signal (see, e.g., JP-A Hei 7(1995)-280603). In this method, characteristics of the operating body are used to improve the precision of the operating body.

In another proposed abnormality detection method applied when the operating body is a rotating body, an applicable digital filter is used to detect signals synchronous with the rotation are extracted (see, e.g., JP-A-2005-335664). In this method, operation characteristics of the operating body are used to improve the abnormality detection precision.

In another proposed method, a time appropriate for abnormality detection is determined by receiving GPS (global positioning system) information to decide if the vehicle is running on a speedway; if so, abnormality detection is performed (see, e.g., JP-A-2001-342889). This method is intended to reduce overlooked abnormalities by performing abnormality detection at an appropriate time.

There is a growing need for outputting an alarm as early as possible after the occurrence of an abnormality. To meet this need, it is desired to improve abnormality detection precision and reduce overlooked abnormalities.

### SUMMARY OF THE INVENTION

Under these circumstances, in order to address the above problems, it is an objective of the present invention to provide an abnormality detection method and an abnormality detection system for an operating body, by which even when the degrees of abnormality or monitoring signals change due to external effects, the progress of the abnormality can be accurately grasped and thereby the abnormality can be precisely detected by eliminating the external effects.

Noting that the degrees of abnormality in an operating body which is continuously operating and monitoring signals are both changed by external effects, the inventor of the present invention achieved an abnormality detection method by which abnormality detection precision can be improved by eliminating the external effects as much as possible.

(1) In an abnormality detection method for an operating body according to one aspect of the present invention, data on an operating body is continuously collected; events for the operating body are detected; part of the data, which is continuously collected, is extracted as target data, the part of the data being collected in a predetermined period is delimited by the above events; the target data is compared with comparison data that is prepared in advance for abnormality detection; and abnormality in the operating body is detected from the comparison result.

In the above aspect (1) of the invention, the following modifications and changes can be made.

(i) Either or both of an output signal of a physical quantity sensor and a control signal for controlling the operating body are collected as the above data.

(ii) Events of a plurality of types are detected; and the above period is delimited by times at which two events of the same type are detected.

(iii) The above events are detected from the above data.

(iv) Data of a plurality of types is collected; the state of the operating body is determined as a plurality of state types according to data of at least one of the plurality of types; and abnormality is detected for each determined state type.

(v) Data of a plurality of types is collected; the state of the operating body is determined as a plurality of state types according to data of at least one of the plurality of types; a partial period is delimited by predetermined state types in the predetermined period delimited by times at which the above events are detected; and part of the data is extracted as target data, the part of the data being collected in a predetermined period delimited by the above events.

(vi) Data on an output signal of a physical quantity sensor and data on a control signal for controlling the operating body are collected; the data of the output signal is subjected to signal processing, the signal processing for the output signal being concurrent with collecting the data on the control signal or being delayed by a predetermined time with respect to collecting the data on the control signal.

(vii) Data on an output signal of a physical quantity sensor and data on a control signal for controlling the operating body are collected; data on the output signal is predicted from the data on the control signal; the predicted data is used as the above comparison data.

(viii) The above target data is processed; and the processed target data is compared with the comparison data, which is processed in advance, to detect an abnormality.

(ix) From a component, which has periodicity, in the above target data, abnormality with a correlation with the periodicity is detected; and from another component, which does not have periodicity, in the above target data, abnormality without the correlation with the periodicity is detected.

(x) The operating body includes a rotating member and a non-rotating member. From a component, which is synchronous with rotation of the rotating member, in the above target data, an abnormality in the rotating member is detected; and from another component, which is not synchronous with the rotation of the rotating member, in the above target data, an abnormality in the non-rotating member is detected.

(xi) The above operating body is an automobile.

(2) An operating body abnormality detection system according to another aspect of the present invention includes: an operating body; a data collecting part for continuously collecting data from the operating body; an event detecting parts for detecting events for the operating body; a target data extracting part for extracting a part of the data, which is continuously collected, as target data, the part of the data being collected in a predetermined period delimited by the above events; a comparison database that stores in advance comparison data used for abnormality detection; and comparison and calculation part for comparing the target data with the comparison data and detecting an abnormality in the operating body from the comparison result.

### Advantages of the Invention

According to the present invention, there are provided an abnormality detection method and an abnormality detection system for an operating body. The method and the system have advantageous in that the abnormality can be precisely detected by eliminating external effects even when the degrees of abnormality or monitoring signals change due to the external effects.

### BRIEF DESCRIPTION OF THE DRAWINGS

FIG. 1 is a schematic illustration showing a structure of an exemplary operating body (automobile) to which an abnormality detection method that embodies the present invention is applied.

FIG. 2 is a schematic illustration showing structures of a steering mechanism and a wheel driving mechanism of the operating body (automobile) to which the abnormality detection method according to the present invention is applied.

FIG. 3 is an electric circuit diagram in an abnormality detection system according to the present invention.

FIG. 4 illustrates timing (distance) diagrams representing changes in road surface height in the wheel driving mechanism in FIG. 2 as well as representing a waveform of vertical acceleration exerted on the wheel driving mechanism.

FIG. 5 illustrates timing diagrams of vertical acceleration exerted on the left and right wheels when a left turn is made by the wheel driving mechanism in FIG. 2.

FIG. 6 illustrates timing diagrams of vertical acceleration exerted on the front and rear wheels when the automobile is accelerated by the wheel driving mechanism in FIG. 2.

FIG. 7A illustrates a timing diagram representing a waveform of the output signal voltage of an acceleration sensor when there is an abnormality in a rotating member in the wheel driving mechanism in FIG. 2.

FIG. 7B shows a timing diagram representing a waveform of the output signal voltage of an acceleration sensor when there is an abnormality in a non-rotating member in the wheel driving mechanism in FIG. 2.

FIG. 8 shows a procedure from event detection to abnormality detection.

FIG. 9 shows timing diagrams representing waveforms of signals to illustrate abnormality detection carried out in a period during which state type A (left turn) continues.

FIG. 10 shows timing diagrams representing waveforms of signals to illustrate abnormality detection in an engine control circuit, which is carried out in a period during which state type P (immediately after start) continues.

FIG. 11 shows another procedure from event detection to abnormality detection.

FIG. 12 shows timing diagrams representing waveforms of signals to illustrate abnormality detection carried out in a wheel part.

FIG. 13 shows timing diagrams representing waveforms of a control signal, electromagnetic noise, a sensor output signal, and a filter output signal, respectively.

FIG. 14 is an example of frequency component distribution of the target data.

### DETAILED DESCRIPTION OF THE PREFERRED EMBODIMENTS

Preferred embodiments of the present invention will be described below with reference to the accompanying drawings. However, the present invention is not limited to the embodiments described herein.

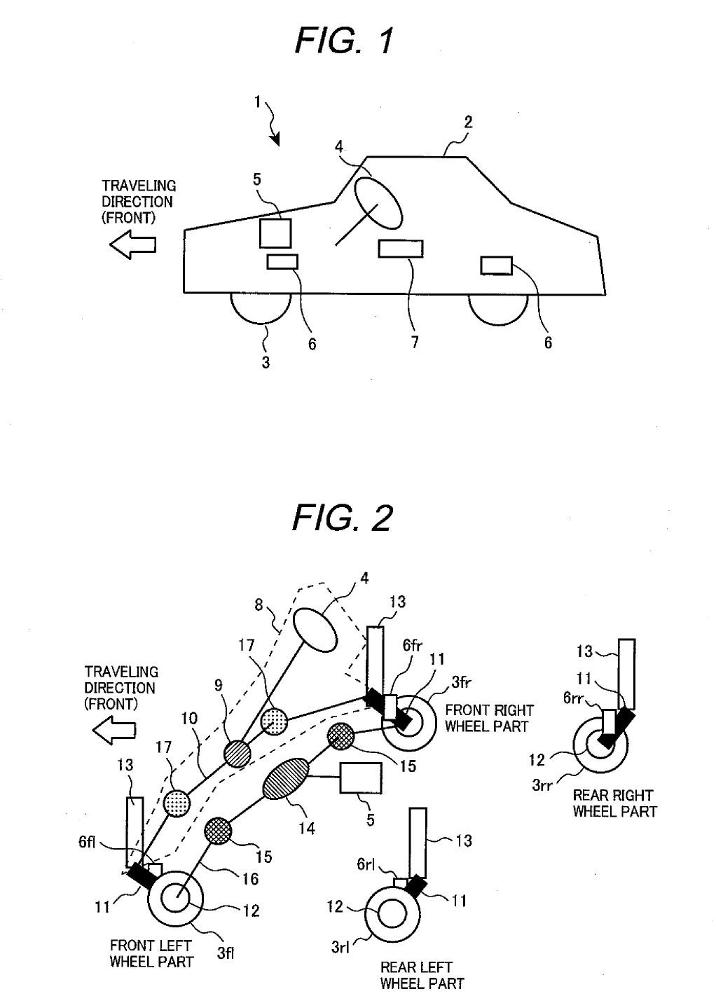

FIG. 1 is a schematic illustration showing a structure of an exemplary operating body (automobile) to which an abnormality detection method that embodies the present invention is applied. As shown in FIG. 1, the operating body 1 has: a body 2; wheels 3 which support the body 2 on the ground and rotate to move the body 2, the wheels being connected to the body 2 through bearings; a steering wheel 4 for performing a steering operation to change the orientation of the wheels 3; an engine 5 that is a driving machine for rotating the wheels 3; a plurality of acceleration sensors 6 disposed at appropriate portions in the body to detect acceleration caused by the body 2 or by members that are part of the body 2; and a data processing unit 7 for implementing the abnormality detection method in the present invention by computer processing.

### First Embodiment of the Invention

In a novel method of detecting abnormality in an operating body 1 according to the present invention, data on the operating body 1 is continuously collected; events for the operating body 1 are detected; the data collected in a predetermined period delimited by these events is extracted as target data; the target data is compared with comparison data which is prepared in advance for abnormality detection; and abnormality in the operating body 1 is detected from the comparison result.

The data is any type of monitoring signal which can be used for detection of an abnormality or events and can also be used for state determination as described later. The data includes output signals indicating physical quantities detected by physical quantity sensors and control signals used to control the operating body by, e.g., manipulations.

If the operating body 1 is an automobile, the data includes: velocity, acceleration, vibration, sound, angular velocity, member distortion, and member temperature caused in part or in the whole of the automobile, for example. Furthermore, if the operating body 1 is an automobile, the events include: data changes associated with road surface shapes, which are caused when, e.g., a step or hollow is passed; data changes associated with manipulation such as rapid steering and rapid acceleration and deceleration; and data changes associated with maintenance such as exchanging wheel and periodic inspection. These events are detected by performing predetermined operations on data (see Table 1 for details). Output of a steering angle sensor for detecting a rotational angle of the steering wheel may be used as data used to detect events associated with steering.

TABLE 1

| | | Road surface shape and |
|---|---|---|
| | | operation state |
| No. | Detection condition | (event) |
| #1 | Comparing threshold with amplitude of | Step passing |
| | acceleration sensor | Hollow passing |
| #2 | Comparing threshold with difference | Rapid steering |
| | between outputs of right and left | |
| | acceleration sensors | |
| #3 | Comparing threshold with difference | Rapid stop |
| | between outputs of front and rear | Rapid acceleration |
| | acceleration sensors | |
| #4 | Comparing frequency characteristics of | Exchanging wheels |
| | acceleration sensor output with | Periodic inspection |
| | predetermined frequency characteristics | |
| | to obtain a similarity between them | |
| #5 | Engine stop signal | Exchanging wheels |
| | Engine start signal | Possibility of period |
| | | inspection |

In the case that the operating body 1 is an automobile, states of the operating body 1 include: states during operations such as turning, acceleration, and deceleration; running states at, e.g., high velocity and low velocity; and weather conditions such as raining and high temperature. In the present invention, the state of the operating body 1 is determined as a plurality of state types, according to at least one type of data (see Table 2 for details). Output of the steering angle sensor may be used as data to determine a state related to turning.

TABLE 2

| | | | Manipulation | |
|---|---|---|---|---|
| | | | state | |
| | | | operation | |
| No. | Decision condition | | state | Symbol |
| $01 | Ratio of output GL of the left-wheel upward | | Left turning | A |
| | acceleration sensor to output GR of the right-wheel | | | |
| | upward acceleration sensor is greater than threshold | | | |
| | Gth1 (Gth1 > 0). | | | |
| $02 | Ratio of output GL of the left-wheel upward | | Right turning | B |
| | acceleration sensor to output GR of the right-wheel | | | |
| | upward acceleration sensor is smaller than threshold | | | |
| | Gth2 (Gth2 < 0). | | | |
| $03 | Ratio of output GL of the left-wheel upward | | Rapid left | C |
| | acceleration sensor to output GR of the right-wheel | | turning | |
| | upward acceleration sensor is greater than threshold | | | |
| | Gth3 (Gth3 > Gth1). | | | |
| $04 | Ratio of output GL of the left-wheel upward | | Rapid right | D |
| | acceleration sensor to output GR of the right-wheel | | turning | |
| | upward acceleration sensor is smaller than threshold | | | |
| | Gth4 (Gth4 < Gth2). | | | |
| $05 | Ratio of output of the forward acceleration sensor to | | Deceleration | E |
| | output of the backward acceleration sensor is smaller | | | |
| | than threshold Gth5 (Gth5 < 0). | | | |
| $06 | Ratio of output of the forward acceleration sensor to | | Acceleration | F |
| | output of the backward acceleration sensor is greater | | | |
| | than threshold Gth6 (Gth6 > 0). | | | |
| $07 | Ratio of output of the forward acceleration sensor to | | Rapid | G |
| | output of the backward acceleration sensor is smaller | | deceleration | |
| | than threshold Gth7 (Gth7 < Gth5). | | | |
| $08 | Ratio of output of the forward acceleration sensor to | | Rapid | H |
| | output of the backward acceleration sensor is greater | | acceleration | |
| | than threshold Gth8 (Gth8 > Gth6). | | | |
| $09 | Ratio of the rotational speed of the left wheel to the | | Slip | I |
| | rotational speed of the right wheel is greater than | | | |
| | threshold Gth91 or smaller than threshold Gth92. | | | |
| $10 | Velocity V is smaller than threshold Vth10 (Vth10 > 0). | | Low-velocity | J |
| | | | running | |
| $11 | Velocity V is greater than threshold Vth11 (Vth11 ≧ 0). | | High-velocity | K |
| | | | running | |
| $12 | Use of ECU output for ABS (applicable when an ABS | | ABS operation | L |
| | operation signal is available) | | | |
| $13 | Wiper operation (applicable when a wire operation | | Rain | M |
| | signal is available) | | | |
| $14 | Thermometer output (applicable when it is greater than | | High | N |
| | threshold Tth14) | | temperature | |
| $15 | Thermometer output (applicable when it is smaller than | | Low | O |
| | threshold Tth15) | | temperature | |
| $16 | Start switch (applicable when the start switch is | | Immediately | P |
| | turned on) | | after start | |
| $17 | *1 | When a decision is made according to the frequency | Running on | Q |
| | | characteristics of the acceleration sensor output: | bad road | |
| | | The ratio of GH17 to GL17 is greater than threshold | | |
| | | RHL17, where GL17 is the integrated value of a | | |
| | | frequency component lower than the frequency | | |
| | | threshold fth17, and GH17 is the integrated value of | | |
| | | a frequency component higher the fth17. | | |
| | *2 | When a decision is made according to the | | |
| | | asynchronism of output signals α1 to α4 of | | |
| | | acceleration sensors 6fl, 6fr, 6rl, and 6rr: | | |
| | | The ratio of α1 to α2 is greater than Gth171 or the | | |
| | | ratio of α3 to α4 is greater than Gth172. | | |
| | *3 | A decision may be made when the condition in either | | |
| | | *1 or *2 is satisfied. | | |

| | | | |
|---|---|---|---|
| $18 | Suspension operation: | Heavy live | R |
| | The output (the height of the body) of a height sensor | load | |
| | for measuring the distance between the body during | | |
| | stopping and the bottom of the suspension is smaller | | |
| | than a threshold. | | |

Data may be processed before being supplied for event detection, state determination, and abnormality detection. For example, data processing includes: statistical processing for obtaining averages, variance, and other values from data collected in an appropriate period (a period between events, a partial period during which the operating body is in a predetermined type of state, or the like); waveform processing for obtaining an amplitude, a frequency, and other parameters; processing for synchronization with wheel rotation (in the case that the operating body is an automobile); selection processing such as filtering; differential processing for obtaining a difference between data obtained from actual motion and predicted data based on motion which is predicted from the amount of manipulation, such as the amount of steering or the amount of braking; and predetermined frequency component removal processing performed in synchronization with transmission of a control signal for power steering control, ABS (antilock braking system) control, or torque apportionment control.

The comparison data is, e.g., data when the operating body 1 is normal or data when the operating body 1 is abnormal. The comparison data can be prepared from conditions under which the operating body 1 is designed or results of a trial operation performed in advance.

FIG. 2 is a schematic illustration showing structures of a steering mechanism and a wheel driving mechanism of the operating body (automobile) to which the abnormality detection method according to the present invention is applied. As shown in FIG. 2, a steering mechanism 8 extends from the steering wheel 4 to the front wheels (front left wheel 3fl and front right wheel 3fr); it has a gear 9, which is rotated by the steering wheel 4, steering shafts 10 with joints 17 at intermediate points, which are moved by the gear 9, and knuckles 11, which are rotated by the steering shafts 10.

The knuckles 11 in the front wheel parts or rear wheel parts are attached to hubs 12. Each knuckle 11 supports the bottom of a suspension 13, and the top of the suspension 13 supports the body 2 in the direction of gravity while absorbing shock. A wheel (front left wheel 3fl, front right wheel 3fr, rear left wheel 3rl, or rear right wheel 3rr) is attached to the outer circumference of each hub 12.

A wheel driving mechanism has a gear 14, which is rotated by the engine (driving machine) 5, joints 15 on the right and left, which transmit the rotation of the gear 14, and axles 16, which are rotated by the joints 15. The hub 12 is rotated by the axle 16.

In this embodiment, the physical sensors for outputting monitoring signals used as data processed by the data processing unit 7 comprise: a front left wheel acceleration sensor 6fl attached to the knuckle 11 in the front left wheel part; a front right wheel acceleration sensor 6fr attached to the knuckle 11 in the front right wheel part; a rear left wheel acceleration sensor 6rl attached to the knuckle 11 in the rear left wheel part; and a rear right wheel acceleration sensor 6rr attached to the knuckle 11 in the rear right wheel part. These acceleration sensors 6 detect acceleration exerted on the individual knuckles 11 in at least one direction.

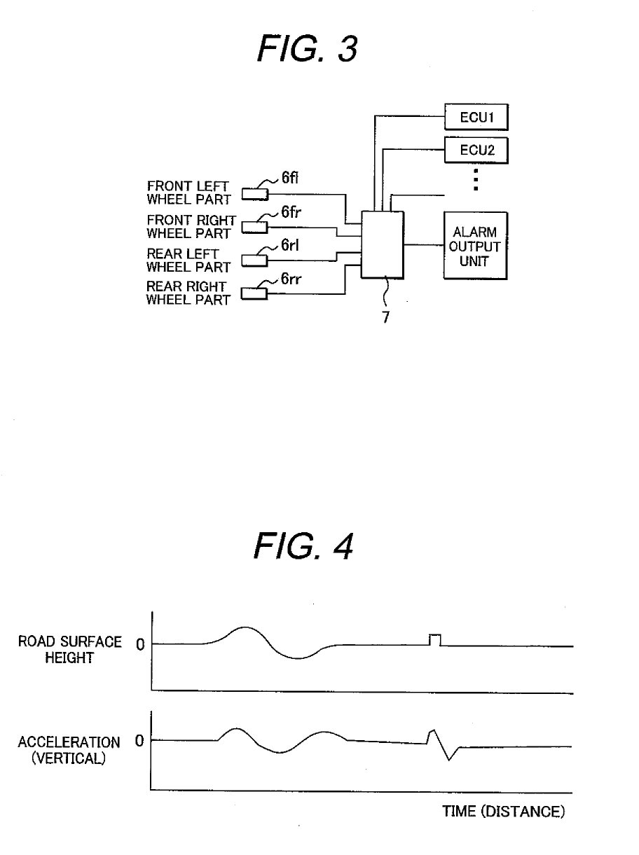

FIG. 3 is an electric circuit diagram in an abnormality detection system according to the present invention. As shown in FIG. 3, output signals from the front left wheel acceleration sensor 6fl, front right wheel acceleration sensor 6fr, rear left wheel acceleration sensor 6rl, and rear right wheel acceleration sensor 6rr are entered in the data processing unit 7. The data processing unit 7 internally includes: the data collecting part; event detecting part; target data extracting part; comparison database; and comparison and calculation part of the abnormality detection system according to the present invention (these parts are not shown). Output signals from a plurality of engine control units ECU1, ECU2, and so on, which control various portions (including those not shown) of the automobile, are also entered in the data processing unit 7. Therefore, the data processing unit 7 can use control data for the various portions of the automobile as data for the data processing unit 7.

Abnormality detection will be outlined below on the assumption that the operating body 1 is an automobile. Abnormalities intended to be detected include: cracks in members such as the hub 12; looseness of bolts for tightening members together; chips and cracks in the bearing; the air pressure in a tire of the wheel 3; and peeling of the tread (the tire surface in contact with a road).

The hub 12, which is rotated by the rotation of the wheel 3, is attached to the knuckle 11, which is a non-rotating member, through a bearing. The acceleration sensor 6 is attached to each of the knuckles 11 at four portions (front left, front right, rear left, and rear right). The sensitivity axis of the acceleration sensor 6 includes a sensitivity axis in the vertical direction, relative to a state in which the automobile is horizontally stationary.

In addition to the output signals from the accelerations sensors 6, other information entered in the data processing unit 7 through control units ECU1, ECU2, and so on includes: information indicating whether the engine 5 is activated; the velocity of the automobile; coolant temperature; atmosphere temperature in the engine room; atmosphere temperatures around the wheels; and the rotational speed of the wheels.

When the automobile runs, the member to which the acceleration sensor is attached moves vertically due to unevenness on the road, changes in velocity, or steering, so the output signal of the acceleration sensor changes. Factors by which the output signal of the acceleration sensor is changed are related to external factors, operation states, and automobile motion, as described below.

Each time the automobile passes a concave or convex on a road surface during straight traveling, the knuckle 11 moves vertically, so the output signal of the acceleration sensor 6 attached to the knuckle 11 changes as shown in FIG. 4. FIG. 4 illustrates timing (distance) diagrams representing changes in road surface height in the wheel driving mechanism in FIG. 2 as well as representing a waveform of vertical acceleration exerted on the wheel driving mechanism. Specifically, when the road surface is gradually and roundly raised from a flat area (with a height of “0”) over a long distance and then gradually and roundly lowered, the acceleration exerted on the knuckle 11 in the direction perpendicular to the road surface is gradually increased from 0 to a positive value, after which the acceleration is reduced and becomes a negative value. After the acceleration reaches the maximum negative value, the absolute value of the acceleration is reduced, and the acceleration changes from negative to positive and then returns to 0 (a positive value indicates upward acceleration and a negative value indicates downward acceleration; this also applies to the following description). When there is a rectangular convex in a short distance on the road surface, the acceleration exerted on the knuckle 11 in the direction perpendicular to the road surface is rapidly increased to a positive value, rapidly decreased to a negative value, and return to 0 in a short time. In the charts of FIG. 4, the velocity of the automobile is constant.

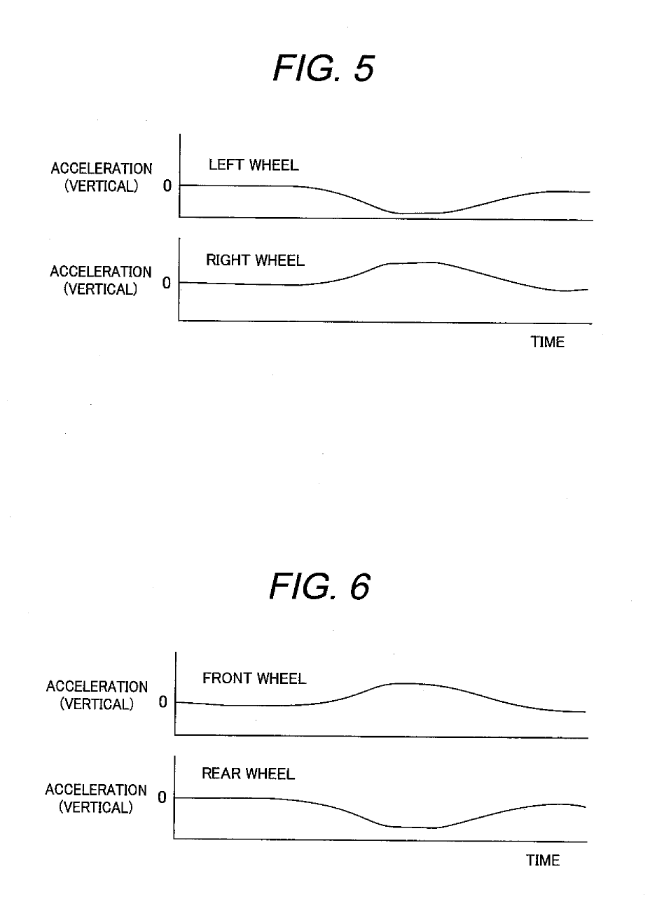

FIG. 5 illustrates timing diagrams of vertical acceleration exerted on the left and right wheels when a right turn is made by the wheel driving mechanism in FIG. 2. When the automobile turns to the right as a result of steering, the left side of the body 2 sinks. Accordingly, the output signals from the acceleration sensors 6 attached to the right and left knuckles 11 change as shown in FIG. 5. That is, at the left wheel, the acceleration gradually decreases from 0 in the negative direction and reaches the negative maximum value, after which the absolute value of the acceleration decreases and the acceleration returns to 0. Conversely, at the right wheel, the acceleration gradually increases from 0 in the positive direction and reaches the positive maximum value, after which the absolute value of the acceleration decreases and the acceleration returns to 0.

FIG. 6 illustrates timing diagrams of vertical acceleration exerted on the front and rear wheels when the automobile is accelerated by the wheel driving mechanism in FIG. 2. When the automobile accelerates, the rear part of the body 2 sinks. Accordingly, the output signals from the acceleration sensors 6 attached to the front and rear knuckles 11 change as shown in FIG. 6. That is, at the front wheel, the acceleration gradually increases from 0 in the positive direction and reaches the positive maximum value, after which the absolute value of the acceleration decreases and the acceleration returns to 0. Conversely, at the rear wheel, the acceleration gradually decreases from 0 in the negative direction and reaches the negative maximum value, after which the absolute value of the acceleration decreases and the acceleration returns to 0.

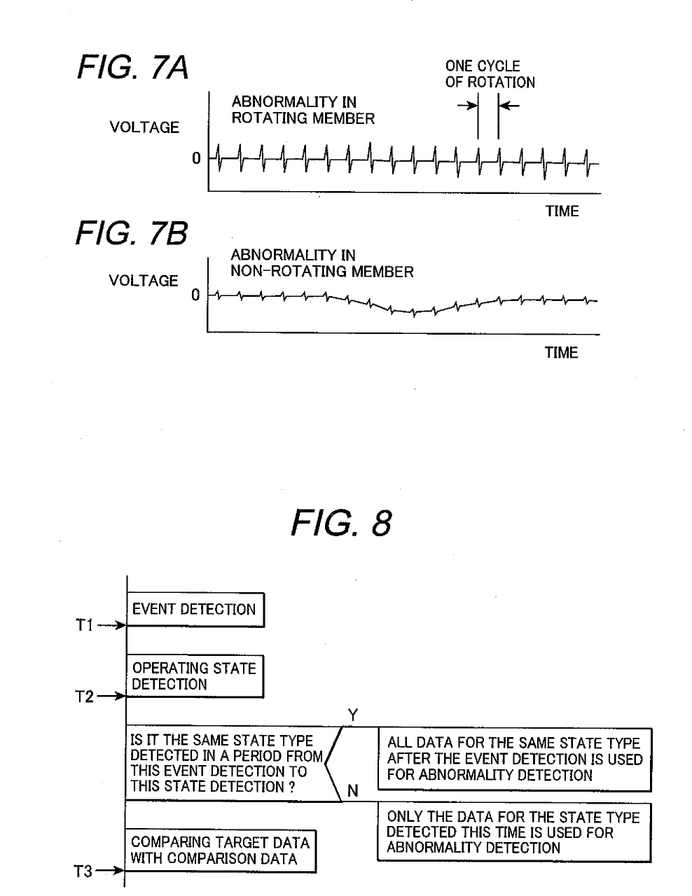

If a rotating member has some type of abnormality such as: uneven wheel rotation; a loose part at which the wheel 3 is fixed to the hub 12; cracks in the hub 12 due to fatigue; or an abnormality in the bearing (not shown), the knuckle 11, to which the acceleration sensor 6 is attached, moves vertically in synchronization with the rotation of the rotating member, so the output signal of the acceleration sensor 6 changes as shown in FIG. 7A. FIG. 7A illustrates a timing diagram representing a waveform of the output signal voltage of an acceleration sensor when there is an abnormality in a rotating member in the wheel driving mechanism in FIG. 2. Specifically, when the road surface is flat and thus the inherent vertical acceleration caused by the road surface is kept at 0, the output signal of the acceleration sensor 6 repeatedly indicates a voltage equivalent to vertical acceleration in the same cycle as the rotation cycle of the rotating member.

If a non-rotating member, such as a part at which the bearing is attached to the operating body 1, the knuckle 11, or the suspension 13 for linking the knuckle 11 and body 2 together, has some type of abnormality, signal components asynchronous with the rotation of the rotating member become dominant, in spite of the presence of signal components synchronous with the rotation of the wheel 3. For example, since the knuckle 11 moves vertically in relation to the road surface shape or operation state, the output signal of the acceleration sensor 6 changes as shown in FIG. 7B. FIG. 7B shows a timing diagram representing a waveform of the output signal voltage of an acceleration sensor when there is an abnormality in a non-rotating member in the wheel driving mechanism in FIG. 2. Specifically, for example, when the voltage is viewed over a long period of time, it gradually decreases from 0 in the negative direction and reaches the negative maximum value, after which the absolute value of the acceleration decreases and the acceleration returns to 0. During this period, a voltage equivalent to the vertical acceleration repeatedly appears in the same cycle as the rotation cycle of the rotating member.

Even if the non-rotating members are normal, the output signals of the acceleration sensors 6 change as shown in FIG. 5 or 6, depending on the operation state such as turning or acceleration. This type of output signal change is similar to the output signal change over a long period of time shown in FIG. 7B. If, however, a non-rotating member has an abnormality, the amplitude may become large or the waveform may change. Relative changes in output signals of the four acceleration sensors attached near the front wheels on the right and left and the rear wheels on the right and left vary depending on whether the non-rotating member is normal or abnormal.

In the present invention, for example, the output signal of an acceleration sensor 6 near a left wheel is denoted as Gl(t) (t indicates a time), and the output signal of an acceleration sensor 6 near a right wheel is denoted as Gr(t). Then, the following relation is obtained.

Left-to-right ratio function:

F(t)=Gl(t)/Gr(t)

When the non-rotating member is normal, the value of the left-to-right ratio function F(t) falls within a constant range, for example, as indicated below.

|F(t)|<F0

If, for example, a left wheel causes an abnormality and thereby the output signal of the acceleration sensor 6 near the left wheel undergoes a large change, the non-cyclic component of F(t) falls outside the constant range. Accordingly, when relative changes in the output signals of the four acceleration sensors 6 are checked in a predetermined period delimited by events or a partial period delimited by state types through event detection or state determination, which will be described later in detail, the abnormality can be located.

It is desirable that an abnormality in a member be found as early as possible, regardless whether the member is a rotating member or a non-rotating member. Although the output signal of the acceleration sensor 6 changes when there is an abnormality, the output also changes depending on the road surface shape or running state even when there is no abnormality. For this reason, it is difficult to use the output signal of the acceleration sensor 6 as a monitoring signal and to precisely determine, from the monitoring signal, whether there is an abnormality.

Abnormality detection precision can be expected to be increased by making the abnormality detection method innovative by, for example, using features of the monitoring signal, selecting an appropriate abnormality detection method according to the operation state, or using operation characteristics of the rotating member, but the prior art is not adequate. The inventor of the present invention considered that an automobile abnormality which becomes problematic in automobile operation occurs, develops (worsens), and becomes obvious when an event occurs due to a road surface shape or an event indicating that the operation state has satisfied a predetermined condition occurs. The present invention has been made on the basis of this idea.

Although data used for abnormality detection may be instant data, data which continues for a certain time is used in this embodiment. To obtain continuous data, a period is delimited and sampling is performed at a predetermined interval in the delimited period to create time-series data. This type of time-series data may be extracted as target data without alteration. Statistical processing may be carried out on the time-series data, in order to calculate an average, a variance, an amplitude, the maximum value, the minimum value, and other statistical values and to extract these calculated values as target data. When the target data is compared with normal data or abnormal data, which is preset as comparison data, an abnormality is detected.

It suffices to use times at which events occur as times to delimit a period during which the sampling of the time-series data starts and ends. When the data in the event-delimited period is extracted as the target data, data used for abnormality detection can be narrowed down to data correlated to a specific road surface shape, manipulation, or maintenance. The target data is extracted from a period delimited by events which affect the occurrence and progress of an abnormality, so a plurality of target data items that are obtained through the same events but in different times correspond to the same abnormality. When the target data is extracted according to the event in this way, the precision in abnormality detection is improved. Furthermore, the occurrence and progress of an abnormality due to the road surface shape, manipulation, or maintenance indicated by events can be easily grasped.

It is also useful to use the same type of events to delimit a period during which the target data is extracted. Then, the amount of target data corresponding to the same type of abnormality increases. Some types of abnormalities may occur and develop due to a certain type of event. When the same type of events are used to delimit a target data extraction period, the amount of target data for degrees of the same type of abnormality increases and thereby the abnormality detection precision can be improved.

For example, suppose that output signals from the acceleration sensors 6 at four portions on an automobile, which is used as the operating body 1, are collected in a case in which two types of events, rapid steering and rapid stop (#2 and #3 in Table 1), occurred in succession in the following order. A rapid stop occurred at date and time ET1; a rapid steering occurred at date and time ET2; a rapid stop occurred at date and time ET3; a rapid steering occurred at date and time ET4, and a rapid stop occurred at date and time ET5. Then, also suppose that it is determined that a decelerated operation ($05 in Table 2, symbol E) occurred: once in a period from ET1 to ET2; once in a period from ET2 to ET3; once in a period from ET3 to ET4; and once in a period from ET4 to ET5. In this case, in abnormality detection in the decelerated operation state, an abnormality is assumed to have occurred when the maximum value of a difference Gdif between the output signal of the front left wheel acceleration sensor 6fl and the output signal of the rear left wheel acceleration sensor 6rl exceeds the threshold Gth5. When abnormality detection is performed in a plurality of periods, an average of differences Gdif among the output signals in the plurality of periods is obtained and compared with the threshold Gth5. If the average exceeds the threshold Gth5, an abnormality is assumed to have occurred.

FIG. 8 shows a procedure from event detection to abnormality detection. Suppose that target data is extracted in partial periods in which the decelerated operation state has been determined in periods delimited by all types of events, according to the procedure shown in FIG. 8. Then, the target data is extracted once in a period from ET1 to ET2, once in a period from ET2 to ET3, once in a period from ET3 to ET4, and once in a period from ET4 to ET5.

A difference between target data items calculated in abnormality detection in the first period from ET1 to ET2 is denoted as Gdif12; a difference in the second period from ET2 to ET3 is denoted as Gdif23; a difference in the third period from ET3 to ET4 is denoted as Gdif34; and a difference in the fourth period from ET4 to ET5 is denoted as Gdif45. In abnormality detection in the first period, the difference Gdif12 is compared with the threshold Gth5; in abnormality detection in the second period, the difference Gdif23 is compared with the threshold Gth5; in abnormality detection in the third period, the difference Gdif34 is compared with the threshold Gth5; and in abnormality detection in the fourth period, the difference Gdif45 is compared with the threshold Gth5.

On the other hand, when target data is extracted in periods delimited only by rapid stop events, two partial periods are formed in a period from ET1 to ET3 and another two partial periods are formed in a period from ET3 to ET5 according to the state decision. In abnormality detection in the first period, an average between the differences Gdif12 and Gdif23 is compared with the threshold Gth5; in abnormality detection in the next period, an average between the differences Gdif34 and Gdif45 is compared with the threshold Gth5.

As described above, when target data is extracted in periods delimited only by rapid stop events, an average between a plurality of target data items extracted in two partial periods is used for comparison with a threshold in abnormality detection in one period. Accordingly, abnormality detection precision becomes higher than when target data is extracted in periods delimited by two types of events.

When data used for abnormality detection is employed for event detection, the degree of relation between an abnormality and the event can be increased, improving abnormality detection precision. For example, in the case that the operating body 1 is an automobile, when the automobile passes over a step or hollow, large vertical acceleration is exerted on the knuckle 11. Accordingly, the body 2 leans fore and aft and side to side, changing balance among accelerations exerted on the knuckles 11 for the wheels. This change in accelerations enlarges mechanical loads applied to related members, which may become a factor for deterioration of the hub 12 and bearing or may develop deterioration. When data related to the occurrence and development of an abnormality is used for abnormality detection, the degree of relation between an abnormality and the event is increased and thereby abnormality detection precision is improved.

If sensors (e.g., acceleration sensors 6) and the data processing unit 7 have been powered on during maintenance, changes in acceleration due to exchanging wheel or the like can be used for event detection. The engine 5 is often stopped during maintenance, and thereby, in general, the sensors are also powered off. When control signals generated by manipulations for starting and stopping the engine 5 are used for event detection, events can be detected while maintenance is carried out. Although the engine 5 is also frequently started and stopped during non-maintenance, when the control signals generated by manipulations for starting and stopping the engine 5 are used for event detection, signals generated in response to a specific abnormality immediately after the start of the engine 5 can be captured in the target data besides signals generated during maintenance. Specific signals immediately after the start of the engine 5 are generated when a member is at relatively low temperature, a difference in temperature between members is small, and an electric circuit fails due to a surge voltage generated at the start of the engine 5.

In the present invention, a period during which abnormality detection is carried out (i.e., target data is extracted) is delimited by events. It is desirable to delimit, in the period, a partial period by a state type representing details of a state, e.g., a partial period during which a predetermined manipulation is carried out or the automobile is in a predetermined operation state, and to use target data in the partial period for abnormality detection. For signals generated due to an abnormality, signals which noticeably appear during the predetermined manipulation or in the predetermined operation state can then be precisely detected.

Operation of the data processing unit 7 will be described below. To use data between consecutive events as target data, the data processing unit 7 operates as described below while the operating body 1 is operating (see FIG. 8).

In the data processing unit 7, the data collecting part continuously collects data from the operating body 1 and the event collecting part detects events from the operating body 1. The data includes output signals indicating physical quantities detected by the physical quantity sensors and control signals by which the operating body 1 is controlled. Events may be detected from the continuously collected data. Events are repeatedly collected. Upon the detection of an event (event detection timing T1), the data processing unit 7 determines the state of the operating body 1 as a plurality of predetermined state types, according to the relevant data or other types of collected data (event detection timing T2).

Subsequent operation of the data processing unit 7 will be described with reference to the examples in Table 3. Table 3 lists results obtained from the processing carried out according to the procedure shown in FIG. 8. Abnormality detection results are not described in Table 3. Processing starting from event detection followed by state determination, target data extraction, and abnormality detection is repeated according to the procedure in FIG. 8.

TABLE 3

| | | Start | End | |
|---|---|---|---|---|
| | | date | date | State type to which |
| | Determined | and | and | abnormality detection is |
| Event | state type | time | time | applied |
| e1 | P | t0(11) | t1(11) | P |
| (starting | | | | |
| engine) | | | | |
| | BG | t0(12) | t1(12) | B, G, BG |
| | Not | t0(13) | t1(13) | No processing |
| | classified | | | |
| | A | t0(14) | t1(14) | A |
| | CH | t0(15) | t1(15) | C, H, CH |
| | A | t0(16) | t1(16) | A (data in period from t0(14) |
| | | | | to t1(14) is also used) |
| | Not | t0(17) | t1(17) | No processing |
| | classified | | | |
| | M | t0(18) | t1(18) | M |
| | AM | t0(19) | t1(19) | A (data in period from t0(14) |
| | | | | to t1(14) and period from |
| | | | | t0(16) to t1(16) are also |
| | | | | used) |
| | | | | M (data in period from t0(18) |
| | | | | to t1(18) is also used), AM |
| e2 | G | t0(21) | t1(21) | G |
| (rapid | | | | |
| stop) | | | | |
| | C | t0(22) | t1(22) | C |
| | A | t0(23) | t1(22) | A (data before e2 is not used) |
| | B | t0(24) | t1(24) | B (data before e2 is not used) |
| e3 | A | t0(31) | t1(31) | A (data before e3 is not used) |
| (passing | | | | |
| over | | | | |
| step) | | | | |
| | B | t0(32) | t1(32) | B (data before e3 is not used) |
| . . . | . . . | . . . | . . . | . . . |

Event e1 was detected in the first event detection. In subsequent state determination, the state in a partial period from t0(11) to t1(11) defined in a period from the start date and time t0(11) to the end date and time t1(11) was determined to be state type P (immediately after start, see Table 2). It was then determined whether the same state type was determined in a period from this event detection (detection of event e1 in this case) to this state type determination. Since the state type determination was carried out immediately after this event detection, there was no record of determination of the same state type. Accordingly, only the target data extracted and subjected to state type determination in the partial period from t0(11) to t1(11) was determined to be applicable. Abnormality detection was then carried out.

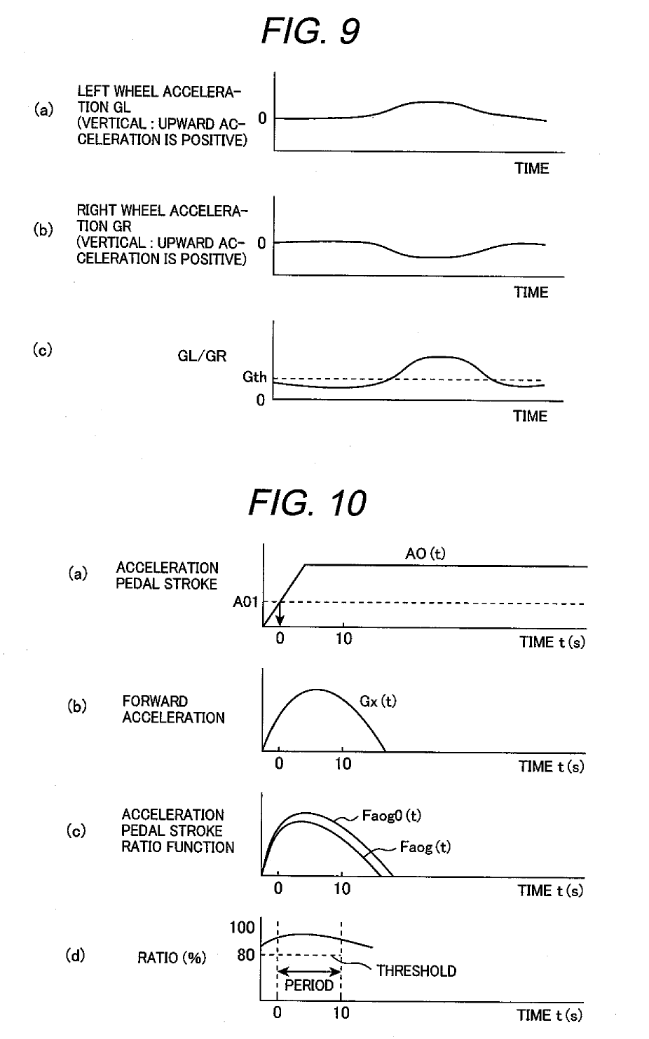

FIG. 9 shows timing diagrams representing waveforms of signals to illustrate abnormality detection carried out in a period during which state type A (left turn) continues. State type A (left turning, see Table 2) is determined because the ratio GL/GR of the left-wheel upper acceleration GL, as shown in FIG. 9(a), to the right-wheel upper acceleration GR, as shown in FIG. 9(b), exceeds the threshold Gth1, as shown in FIG. 9(c).

Although the state type in a partial period from t0(16) to t1(16) was determined to be A, the same state type A as determined in the period from the detection of event e1 to the state determination was also detected in a partial period from t0(14) to t1(14). Accordingly, the data extracted in the partial period from t0(14) to t1(14) was used as target data besides the data in the partial period from t0(16) to t1(16). Abnormality detection was then performed on the target data in these partial periods. Various abnormality detection conditions can be thought; if, for example, abnormality detection is carried out depending on whether the peak of the output signal of the acceleration sensor 6 exceeds comparison data Gth1 in a delimited partial period, when the maximum value in the partial period from t0(14) to t1(14) is G14 and the maximum value in the partial period from t0(16) to t1(16) is G16, exemplary processing for reducing the effects exerted on error in the target data used for abnormality detection is to use an average between the maximum values G14 and G16.

How target data is extracted in a partial period from t0(23) to t1(23) in which state type A was determined for event e2 will be described. The partial period in which state type A was determined is present before the determination of state type A. When a decision is made according to the procedure in FIG. 8, however, there is no determination of state type A after event e2 was detected this time. Accordingly, only the target data in the partial period from t0(23) to t1(23) in which state type A was determined is applicable.

The data processing unit 7 stores in advance comparison data, which is used for abnormality detection, in the comparison database. In the data processing unit 7, the comparison and calculation part compares the target data with the comparison data. If the difference between the target data and the comparison data is greater than or smaller than a threshold, the comparison and calculation part decides that the operating body 1 includes an abnormality (abnormality detection result output timing T3 in FIG. 8).

State type P (immediately after start) will be described as an example, with reference to FIG. 10. FIG. 10 shows timing diagrams representing waveforms of signals to illustrate abnormality detection in an engine control circuit, which is carried out in a period during which state type P (immediately after start) continues. In state type P (immediately after start), an electric circuit may fail due to a surge voltage at the start time. If, for example, an electric circuit for controlling the engine fails, an abnormality in which acceleration generated in response to the travel of the acceleration pedal is smaller than normal can be detected because fore and aft acceleration corresponding to the output from an acceleration pedal stroke sensor is smaller than normal.

An exemplary abnormality will be described below. FIG. 10(a) illustrates acceleration pedal stroke sensor output AO(t), FIG. 10(b) illustrates forward acceleration Gx(t) corresponding to the acceleration pedal stroke, and FIG. 10(c) illustrates an acceleration stroke ratio function calculated from AO(t) and Gx(t) as indicated below.

Acceleration pedal stroke ratio function:

Faog(t)=Gx(t)/AO(t)

FIG. 10(d) compares this ratio with the ratio Faog0(t) of normal forward acceleration to the corresponding acceleration pedal stroke, as a ratio. To detect an abnormality, a threshold is set; when, for example, the ratio is smaller than the threshold by 20% or more, an abnormality is determined to have been detected. In this case, a time at which the acceleration pedal stroke exceeds the predetermined value A01 is taken as 0, and comparison is made for, e.g., 10 seconds, starting from time 0.

Since no event was detected during an attempt to detect an event by returning to the beginning of the procedure in FIG. 8, state determination was then carried out; in the state determination, the state type in a partial period from t0(12) to t1(12) was determined to be state type BG (manipulation state and operation state in which right turning and rapid deceleration were performed concurrently, see Table 2). It was then determined whether the same state type was determined in a period from this event detection (detection of event e1 in this case) to this state type determination. Since the manipulation state and operation state were such that state type B and state type G were concurrently carried out, state types B, G, and BG were determined to be the same state types.

Since the manipulation state and operation state intended to be determined did not occur in a period from this event (e1) detection to this state determination, only the target data in the partial period from t0(12) to t1(12) in which this state decision was performed was extracted. The same processing was repeated, but no applicable state type was detected in a partial period from t0(13) to t1(13), so target data was not extracted. This processing was repeated.

Another operation by the data processing unit 7 will be described next.

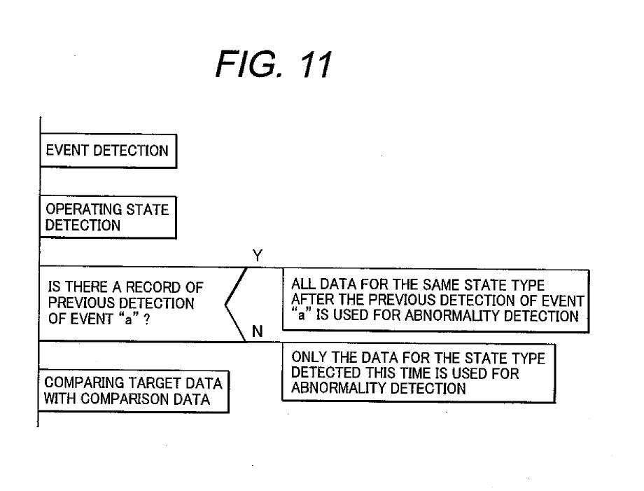

FIG. 11 shows another procedure from event detection to abnormality detection. A procedure shown in FIG. 11 will be described. Table 4 shows an example in which periods from which to extract target data are delimited by events of the same type out of a plurality of types, together with processing results performed according to the procedure shown in FIG. 11.

TABLE 4

| | | Start | End | |
|---|---|---|---|---|
| | De- | date | date | State type to which |
| | termined | and | and | abnormality detection is |
| Event | state type | time | time | applied |
| e1 | P | t0(11) | t1(11) | P |
| (starting | | | | |
| engine) | | | | |
| | BG | t0(12) | t1(12) | B, G, BG |
| | Not | t0(13) | t1(13) | No processing |
| | classified | | | |
| | A | t0(14) | t1(14) | A |
| | CH | t0(15) | t1(15) | C, H, CH |
| | A | t0(16) | t1(16) | A (data in period from t0(14) |
| | | | | to t1(14) is also used) |
| | Not | t0(17) | t1(17) | No processing |
| | classified | | | |
| | M | t0(18) | t1(18) | M |
| | AM | t0(19) | t1(19) | A (data in period from t0(14) |
| | | | | to t1(14) and period from |
| | | | | t0(16) to t1(16) are also |
| | | | | used) |
| | | | | M (data in period from t0(18) |
| | | | | to t1(18) is also used), AM |
| e2 | G | t0(21) | t1(21) | G |
| (rapid | | | | |
| stop) | | | | |
| | C | t0(22) | t1(22) | C |
| | A | t0(23) | t1(22) | A (data before e2 is not used) |
| | B | t0(24) | t1(24) | B (data before e2 is not used) |
| e3 | A | t0(31) | t1(31) | A (data before e3 is not used) |
| (passing | | | | |
| over | | | | |
| step) | | | | |
| | B | t0(32) | t1(32) | B (data before e3 is not used) |
| . . . | . . . | . . . | . . . | . . . |
| e4 | P | t0(41) | t1(41) | P (data in period from t0(11) |
| (stopping | | | | to t1(11) is also used) |
| and | | | | |
| starting | | | | |
| engine) | | | | |
| | A | t0(42) | t1(42) | A (data in period from t0(31) |
| | | | | to t1(31) is also used) |
| | B | t0(43) | t1(43) | B (data in period from t0(32) |
| | | | | to t1(32) is also used) |
| e5 | A | t0(51) | t1(51) | A (data before e5 is not used) |
| (passing | | | | |
| over | | | | |
| step) | | | | |
| | B | t0(52) | t1(52) | B (data before e5 is not used) |
| . . . | . . . | . . . | . . . | . . . |

Processing starting from event detection followed by state determination, target data extraction, and abnormality detection is repeated according to the procedure in FIG. 11. The procedure in FIG. 11 differs from the procedure in FIG. 8 in target data extraction. Processing up to the detection of event e4 in Table 4 is the same as the processing according to the procedure in FIG. 8 because events of the same type did not occur. Although start after an engine stop was detected at event e4, another engine start was detected at event e1, so a date and time from which target data extraction starts is regarded as time and date t0(11) from which event e1 started. Accordingly, when abnormality detection is performed for the state type P in a period from t0(41) to t1(41), target data was extracted in a period from t0(11) to t1(41). In this period, state type P was determined twice in the partial period from t0(11) to t1(11) and the partial period from t0(41) to t1(41).

If, for example, an electric circuit for controlling the engine fails, an abnormality in which acceleration generated in response to the travel of the acceleration pedal is smaller than normal can be detected by comparing Faog(t) with the ratio Faog0(t) of normal forward acceleration to the corresponding acceleration pedal stroke; as described before, Faog(t) is calculated from the acceleration pedal stroke sensor output AO(t) and forward acceleration Gx(t) corresponding to the acceleration pedal stroke.

Acceleration pedal stroke ratio function:

Faog(t)=Gx(t)/AO(t)

When, for example, the comparison result indicates a reduction of 20% or more, an abnormality is determined to have been detected. A time at which the acceleration pedal stroke exceeds the predetermined value A01 is taken as 0, and comparison is made for, e.g., 10 seconds, starting from time 0. Since two target data items were extracted, the acceleration pedal stroke ratio function Faog(t) was calculated for the two target data items, according to the procedure in FIG. 11 (the calculation results are Faog1(t) and Faog2 (t)). An average of calculation results Faog1(t) and Faog2(t) is represented as the acceleration pedal stroke ratio function Faog(t). When the acceleration pedal stroke ratio function Faog(t) is compared with ratio Fago0(t) in normal time, a reduction of 20% or more from the normal time is determined as an abnormality, for example. In the abnormality performed on the target data extracted in this example, the average between Faog1(t) and Faog2(t) obtained from the two target data items is taken and represented as the acceleration pedal stroke ratio function Faog(t) for abnormality detection, so the abnormality detection precision can be made higher than when only one target data item is used.

In the abnormality detection system in FIG. 3, the data processing unit 7 collects output signals from the four acceleration sensors 6 as data, collects output signals, which indicate velocity, temperature, and other parameters, from some control units ECU1, ECU2, and so on as data, and checks these types of data against preset event detection conditions to detect events. That is, event conditions are set for each type of event in the data processing unit 7, as indicated in Table 1. Road surface shapes and operation states are defined in correlation with the relevant events.

With event #1 (see Table 1), for example, data of output signals from at least one of the acceleration sensors 6 is processed to obtain an amplitude and the obtained amplitude is compared with a predetermined threshold. A point in time at which event #1 is detected is an instant when the amplitude exceeds or drops below the threshold. Event #1 is largely correlated to acceleration exerted on the knuckle 11 when the automobile passes over a step or passes a hollow.

With event #4 (see Table 1), data of output signals from at least one of the acceleration sensors 6 is processed to obtain frequency characteristics and a degree of similarity between the obtained frequency characteristics and predetermined frequency characteristics. A point in time at which event #4 is detected is an instant when the degree of similarity exceeds or drops below the threshold. Event #4 is largely correlated to exchanging wheel and periodic inspection.

When an operation for removing the bolts that secure a wheel starts during exchanging wheel or a tool is used during inspection, a large force needs to be rapidly applied, increasing the high-frequency component of the output signal of the acceleration sensor 6. Accordingly, the ratio RHL between an integrated value GLow of a frequency component lower than a frequency threshold Fth and an integrated value GHigh of a frequency component higher than the frequency threshold Fth may be calculated to determine the point in time at which event #4 is detected as a time at which the ratio RHL becomes larger than a predetermined threshold RHL0.

As described above, the data processing unit 7 detects the occurrence of an event and its type on the basis of output signals from the acceleration sensors 6 and output signals from control units ECU1, ECU2, and so on. In addition, the data processing unit 7 uses a plurality of types of data as described above to determine a state type with reference to preset decision conditions. Specifically, decision conditions are set in the data processing unit 7 for each state type, as indicated in Table 2; each state type identifies a manipulation state of the automobile or operation state, so an identification symbol is given to each state type in the data processing unit 7.

For example, the state of the automobile is determined to be state type $01 (see Table 2) when the ratio of the output signal of the left-wheel upper acceleration sensor to that of the right-wheel upper acceleration sensor is compared with a threshold, and the obtained ratio is larger than the threshold. State type $01 is largely correlated to a manipulation state in which the automobile has been steered to the left and an operation state in which the automobile has turned to the left. State type $01 is denoted A.

Similarly, state type $02 (see Table 2) is determined when the ratio of the output signal of the left-wheel upper acceleration sensor to that of the right-wheel upper acceleration sensor is compared with a threshold, and the obtained ratio is smaller than the threshold. State type $02 is largely correlated to a manipulation state in which the automobile has been steered to the right and an operation state in which the automobile has turned to the right (see FIG. 5). State type $02 is denoted B.

As described above, the data processing unit 7 determines the state of the automobile as a plurality of state types on the basis of output signals from the acceleration sensors 6 and output signals from control units ECU1, ECU2, and so on.

After detecting an event, the data processing unit 7 compares target data with comparison data for each state type which the data processing unit 7 has determined in order to detect an abnormality. Specifically, the data processing unit 7 extracts, as target data, data in a period from a start time and date to an end time and date for each data type according to the event type and state type, as indicated in Table 3.

The state type symbols in Table 3 are the symbols defined in Table 2. When a plurality of state types occur concurrently, the symbols of these state types are listed in succession. For example, the symbol AE (not indicated in Table 3) indicates that a left turn (symbol A) and deceleration (symbol E) occur concurrently, which is largely correlated to an operation state in which the automobile decelerates while turning to the left. When more than two or three state types occur concurrently, the symbols of these state types are listed accordingly in succession.

The data processing unit 7 processes the target data extracted as described above to calculate an average, a variance, an amplitude, the maximum value, the minimum value, and other statistical values (it is assumed that statistical processing and processing for a frequency domain are performed). If statistical processing is performed on comparison data in advance, the calculation time can be shortened. If only comparison data after statistical processing is stored, the storage area can be reduced by deleting data that is not to be stored.

The data processing unit 7 compares the target data extracted as described above or the target data processed as described above with comparison data for abnormality detection. In specific calculation for comparison, a ratio of a function value calculated from two types of target data to a function in a normal state is obtained; when the obtained ratio exceeds (or falls below) a predetermined percent, it is assumed that an abnormality is detected.

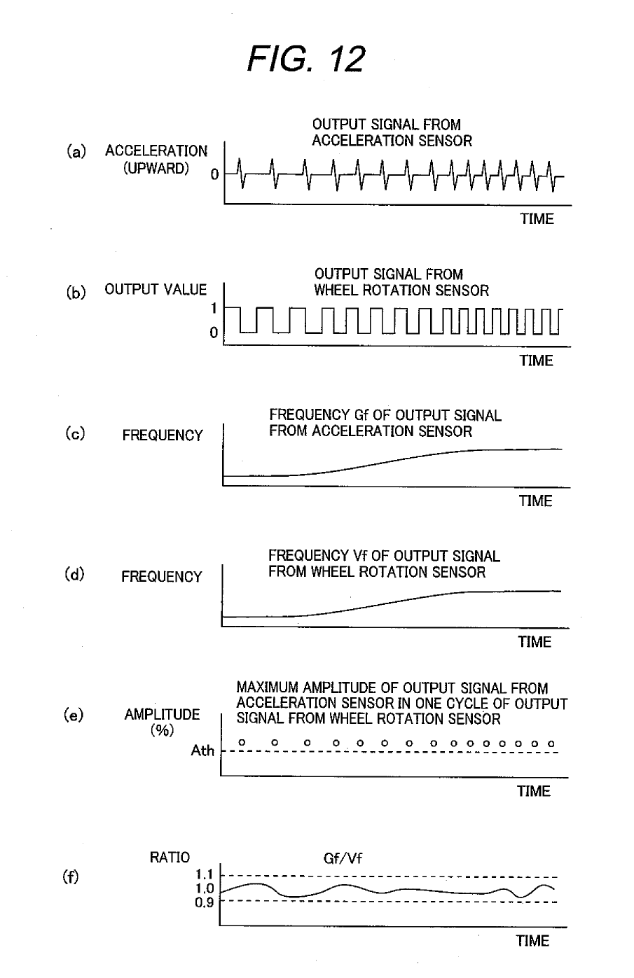

A case in which an abnormality is detected from a wheel will be described as a specific example, with reference to FIG. 12. FIG. 12 shows timing diagrams representing waveforms of signals to illustrate abnormality detection carried out in a wheel part. Monitoring signals are an output signal of the upward acceleration sensor attached to the knuckle 11 and an output signal of a wheel rotation sensor which outputs an inverted logic signal, one cycle of which corresponds to one turn of the wheel 3. Data on these monitoring signals are collected. Target data is collected for a predetermined period, according to event detection and state determination (not shown). The output signal, shown in FIG. 12(a), from the upward acceleration sensor and the output signal, shown in FIG. 12(b), from the wheel rotation sensor are extracted. Data processing for analyzing the frequency of the output signal of the upward acceleration sensor and the frequency (1/T) of the output signal of the wheel rotation sensor is then performed, producing frequency changes Gf and Vf with time shown in FIGS. 12(c) and 12(d). When the maximum amplitude of the output signal of the upward acceleration sensor is extracted for each cycle of the output signal of the wheel rotation sensor as indicated by open circles (◯) in FIG. 12(e). FIG. 12(f) shows the ratio Gf/Vf between the frequency changes Gf and Vf with time as the degree of similarity.

When each maximum amplitude exceeds a threshold Ath and the ratio Gf/Vf between the frequency changes Gf and Vf with time falls within a predetermined range, e.g., from 1 to 1.1, it can be said that upper acceleration greater than a predetermined value is generated for each rotation of the wheel 3 and there is similarity in frequency characteristics between the upper acceleration and the wheel rotation. It is then detected that abnormality synchronous with the rotation of the wheel 3 has occurred.

When the ratio Gf/Vf between the frequency changes Gf and Vf with time is close to 1, it indicates that the change in the upper acceleration is in synchronization with the rotation of the wheel 3. Whether the maximum amplitude of the output signal of the upper acceleration sensor exceeds the threshold Ath in one cycle of the output signal of the wheel rotation sensor is correlated to whether there is an abnormality. Possible abnormalities synchronous with the rotation of the wheel 3 include: uneven wheel rotation; looseness at a part where the wheel 3 is secured to the hub 12; cracks generated by fatigue of the hub 12; and bearing abnormalities. Which one of these abnormalities has occurred is not identified here, but identification of a subsequent abnormality becomes possible by detection of an abnormality from which a monitoring signal synchronous with the rotation is obtained.

Abnormality detection is preferably carried out for each state type. Furthermore, a plurality of intermediate results, each of which is a detection result for each state type, may be combined together to obtain detection results of a combination of a plurality of state types, making detailed detection possible.

For example, suppose that abnormality synchronous with the rotation of the wheel 3 was detected in state type C (rapid left turn, see Table 2), but the same abnormality was not detected in state type A (left turn, see Table 2). In this case, it can be determined that the degree of the abnormality is relatively small. If, however, the above abnormality was detected in both state types C and A, it can be determined that the degree of the abnormality is large. When intermediate results for individual state types are combined as described above for final detection, an abnormality can be detected in detail. The level of an alarm can thereby be changed according to the degree of the abnormality, for example.

In abnormality detection for each state type, one state type or a combination of a plurality of state types may be used. These types of abnormality detection may be carried out more than once. For example, suppose that abnormality detection in state type A and abnormality detection in state type AI are carried out. As indicated in Table 2, the state type A is related to a left turn, and the state type I is related to a slip. When abnormality detection is carried out more than once, detailed abnormality detection is possible.

For example, in a case in which an abnormality resulting in a monitoring signal synchronous with the rotation of the wheel 3 was detected in state type A (left turn), but this abnormality was not detected in state type AI (left turn and slip), the degree of the abnormality may be smaller than when the above abnormality was detected in the state AI. This is because the load applied to the wheel 3 is released due to the slip of the tire of wheel 3 and thus abnormality does not appear in the monitoring signal. When the same abnormally is detected more than once in a plurality of state types in this way, detailed detection becomes possible.

According to the abnormality detection method described above, data on the operating body 1 is continuously collected; events for the operating body 1 are detected; part of the data, which is continuously collected, is extracted as target data, the part of the data being collected in a predetermined period delimited by the above events; the target data is compared with comparison data that is prepared in advance for abnormality detection; and abnormality in the operating body 1 is detected from the comparison result. Accordingly, even when the degree of abnormality or a monitoring signal changes due to external effects, the progress of the abnormality can be accurately grasped and thereby an abnormality can be precisely detected by eliminating the external effects.

### Second Embodiment of the Invention

Another embodiment of the present invention will be described below.

In the case that the operating body 1 is an automobile, monitoring signals (output signals from the acceleration sensors 6, for example) may be classified into signals synchronous with the rotation of the wheel 3 and asynchronous signals. The rotational speed (angular speed) of each wheel 3 can be detected from the output pulse generated by, e.g., a wheel rotation sensor attached near the wheel 3 for an antilock braking system (ABS). The rotational speed of the wheel 3 can also be detected by counting the number of output pulses generated by the wheel rotation sensor for one turn of the wheel 3. The number of output pulses generated from the wheel rotation sensor for one turn of the wheel 3 depends on the design of the wheel rotation sensor. It is preferable to classify the monitoring signals into signals synchronous with the rotation of the wheel 3 and asynchronous signals according to the detected rotational speed (or the number of output pulses generated by the wheel rotation sensor) of the wheel 3. The data processing unit 7 classifies target data obtained from output signals of the acceleration sensors 6 into signals synchronous with the rotation of the wheel and asynchronous signals, on the basis of this idea.

The signals synchronous with the rotation of the wheel 3 can be used to detect an abnormality in: the hub 12; the bearing for retaining the hub 12; the axle 16; the gear 14; and nuts (or bolts) for attaching the wheel 3 to the hub 12. Furthermore, an abnormality in tread of a tire can be detected. On the other hand, the signals asynchronous with the rotation of the wheel 3 can be used to detect an abnormality in the knuckle 11, suspension 13, joint 15, and a tire attached to the wheel 3. Additionally, abnormal air pressure in the tire of the wheel 3 can be detected.

If the air pressure in the tire of the wheel 3 drops, up and down motion due to an uneven road surface is not easily transmitted to the acceleration sensor 6. If the air pressure in one of the four tires (fore and aft and right and left) drops, the amplitude of the output signal of the acceleration sensor 6 near the wheel 3 under the reduced air pressure becomes lower than those from the acceleration sensors 6 near the other wheels 3. Up and down motion due to the uneven road surface is more dominant than up and down motion synchronous with the rotation of the wheel 3, so the up and down motion due to the air pressure drop in the tire is detected as a signal asynchronous with the rotation of the wheel 3. Data asynchronous with the rotation of the wheel 3 is then separated from target data obtained from the output signals of the acceleration sensors 6 for the four wheels 3 (fore and aft and right and left), and the amplitudes in the four separated data items are compared. If there is data the amplitude of which is smaller than the amplitudes in the other data items by at least a predetermined value (predetermined ratio), it can be determined that the air pressure in the tire near the acceleration sensor 6 representing the smaller amplitude is abnormal.

The embodiment in which target data is classified into data of synchronous signals and asynchronous data is not limited to the operating body 1 having rotating members; the embodiment can also be applied to operating bodies including reciprocating members, swinging members, and cyclically vibrating members. It is preferable to detect an abnormality correlated to cyclicity from cyclic components in the target data and to detect an abnormality not correlated to cyclicity from non-cyclic components in the target data.

In the case that the operating body 1 is an automobile, motion exerted on the automobile can be predicted from amounts of manipulation (an amount by which the steering wheel is steered and an amount by which the brake pedal is depressed). Acceleration exerted on a member to which the acceleration sensor 6 is attached can be predicted from the predicted motion. If a difference calculated between the predicted acceleration and actually measured acceleration does not fall within a predetermined range, an abnormality can be determined to have occurred. Specifically, the data processing unit 7 predicts motion which would be exerted on the automobile from an amount of manipulation included in a control signal, and also predicts data that would be obtained from the acceleration sensor 6 from the predicted motion. The data processing unit 7 uses the predicted data as comparison data to compare target data obtained from the output signal of the acceleration sensor 6 with the comparison data.

An exemplary motion prediction method will be described for the case in which the operating body 1 is an automobile. A motion equation for an automobile can be represented as follows.

$$\begin{matrix}m V \frac{d β}{d t} + 2 ( {K}_{f} + {K}_{r} ) β + \{ m V + \frac{2}{V} ( {l}_{f} {K}_{f} - {l}_{r} {K}_{t} ) \} γ = 2 {K}_{r} δ & Eq . ( 1 ) \\ 2 ( {l}_{f} {K}_{f} - {l}_{r} {K}_{r} ) β + I \frac{d γ}{d t} + \frac{2}{V} ( {l}_{f}^{2} {K}_{f} + {l}_{r}^{2} {K}_{r} ) γ = 2 {l}_{f} {K}_{r} δ & Eq . ( 2 ) \\ d β = γ - \frac{{G}_{y}}{V} & Eq . ( 3 ) \\ β = \int d β d t & Eq . ( 4 )\end{matrix}$$

Here,

m: Mass of vehicle;

I: Inertia yawing moment of vehicle;

l_{f}: Distance between center of gravity of vehicle and front-wheel axle;

lᵣ: Distance between center of gravity of vehicle and rear-wheel axle;

K_{f}: Tire cornering power per front wheel;

Kᵣ: Tire cornering power per rear wheel;

V: Velocity of vehicle;

G_{y}: Acceleration in horizontal direction;

δ: Real steering angle of front wheel;

β: Sideslip angle at center of gravity of vehicle;

γ: Yaw angular rate of vehicle; and

t: Time.

Of the variables in Eqs. (1) to (4), mass m, inertia moment I, distance l_{f} between the center of gravity of the vehicle and the front-wheel axle, and distance lᵣ between the center of gravity of the vehicle and the rear-wheel axle are determined as design values. Velocity V of the vehicle, steering angle δ, yaw angular rate γ, and acceleration Gy in a horizontal direction are detected by sensors. When these variables are known, cornering power K_{f} and cornering power Kᵣ can be determined.

The amount of steering is equivalent to the steering angle δ. The velocity V is changed when the brake pedal is depressed. Cornering power K_{f} and cornering power Kᵣ are equivalent to a force exerted between the tire of the wheel 3 of the automobile and the road surface. Since it can be thought that the motion of the automobile is restrained only by the road surface, the motion of the automobile can be understood.

Although the sideslip angle β at the center of gravity of the vehicle is calculated according to motion Eq. (4) for an automobile, sideslip angle β₂ can be determined from acceleration and velocity according to Eq. (5), as described below. When the sideslip angle β₂ is calculated according to Eq. (5) as compared with sideslip angle β calculated according to Eq. (4), abnormality detection by means of the acceleration sensor 6 becomes possible.

$${β}_{2} = \frac{1}{2} π - arctan ( \frac{{G}_{y} - {V}_{y}^{*}}{{G}_{x} - {V}_{x}^{*}} ) \qquad Eq . ( 5 )$$

Here,

β₂: Sideslip angle obtained from acceleration;

G_{y}: Acceleration in horizontal direction (measured value);

Gₓ: Acceleration in fore-and-aft direction (measured value);

Vₓ*: Rate of change in fore-and-aft velocity with time (rate of change in vehicle velocity V with time); and

V_{y}* Rate of change in horizontal velocity with time (rate of change in horizontal velocity Vy with time,

V_{y}=V×tanβ, β obtained from Eq. (4)).

In a case that the operating body 1 is an automobile in which electric power steering control, ABS control, and control of driving torque distribution to the wheels are carried out, when electric power steering control signals, ABS control signals, and driving torque distribution control signals are used as the monitoring signal data, the control signals may generate noise in the monitoring signal data due to the transmission timing of each control signal. Another problem is caused by electromagnetic noise generated when an electric motor and other units under control are operated while being controlled by these control signals; the electromagnetic noise may be superimposed on the monitoring signal data.

In the present invention, the frequencies of the noise sources and a time by which electromagnetic noise generation is delayed with respect to the control signal output timing are measured in advance and the measured values can be set in the data processing unit 7. For the monitoring signal synchronous with each control signal, the frequency component of the noise source is removed from the target data during a period when the voltage of the control signal changes considering a delay time, which is predetermined with constants for motor operation and the like, and which elapses after the voltage of the control signal changes, so that the frequency component is not affected in periods in which the noise is not superimposed. Since an abnormality is detected from the target data from which the frequency component of the noise source has been removed, incorrect detection due to the noise can be prevented.

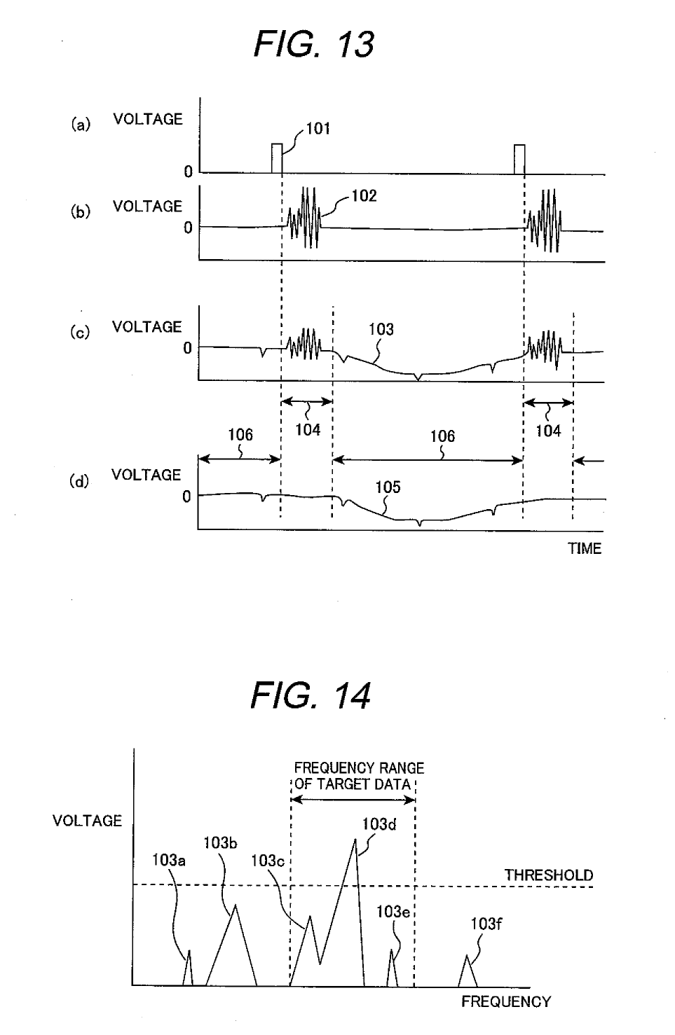

FIG. 13 shows timing diagrams representing waveforms of a control signal, electromagnetic noise, a sensor output signal, and a filter output signal, respectively. Specifically, FIG. 13(a) shows the waveform of a brake control signal 101; FIG. 13(b) shows the waveform of electromagnetic noise 102 from the brake control signal 101; and FIG. 13(c) shows the waveform resulting from superimposing the electromagnetic noise 102 to the output signal (sensor output signal 103) of the acceleration sensor 6 attached near the wheel. After the control signal 101, which has a rectangular impulse waveform, is output and then a delay time elapses, the electromagnetic noise 102, which includes a relatively high frequency component, is generated from the unit under control. The sensor output signal 103 includes a signal component which is similar to the waveform synchronous with the delayed electromagnetic noise from the unit under control, the signal component being superimposed to the intrinsic output signal (comprising a component with a gradually curved waveform that is equivalent to the waveform in FIG. 7B and another component that is generated due to abnormality synchronous with the rotation of the wheel 3, the another component being a cyclic signal with an inverted triangular impulse waveform).

When a filter period 104 during which the electromagnetic noise 102 continues and the frequency band of the electromagnetic noise 102 are checked in advance, low-pass filtering can be carried out to cut the frequency band only during the filter period 104. In the low-pass filtering, it is assumed that the frequency band of the electromagnetic noise is the same as the frequency band of the component having pulses which appear repeatedly in short cycles.

As shown in FIG. 13(d), a filtered output signal 105 is obtained by cutting the above frequency band in a plurality of filter periods 104 which discretely appear. All components similar to the electromagnetic noise, which are included in the sensor output signal 103, are removed. The component included in the sensor output signal 103 and synchronous with the rotation of the wheel 3, the component having pulses that appear repeatedly in short cycles, is eliminated in the filter period 104, but remains in a non-filter period 106 without being removed. The component with a gradually curved waveform, which is the intrinsic output signal, also remains.

Even when a plurality of components with different factors and characteristics are superimposed on the monitoring signal, waveform processing as shown in FIGS. 13(a) to 13(d) enables one component to be completely removed and another component to be detected in a period in which components are not mutually superimposed. When, for example, the frequency band of a signal component associated with an abnormality generated in synchronization with the rotation of the wheel 3 is superimposed on the frequency band of a signal associated with electromagnetic noise, the signal component associated with an abnormality generated in synchronization with the rotation of the wheel 3 remains in the target data during periods in which the electromagnetic noise 102 is not generated, enabling the abnormality to be detected.

Data shown in FIG. 13(d), which is obtained by applying low-pass filtering to the data in the period in which the electromagnetic noise is generated, is used as target data. A fast Fourier transform (FFT) is executed on the target data, which is time-series data, to convert it to frequency domain data, as shown in FIG. 14. FIG. 14 is an example of frequency component distribution of the target data. In this case, time response is also converted to frequency response. As the drawing indicates, the target data obtained by the FFT has components 103c, 103d, and 103e included in the frequency range of a signal associated with an abnormality and components 103a, 103b, and 103f not included in the frequency range. Of the components included in the frequency range of the target data, the voltage of the component 103d exceeds the threshold, enabling the abnormality to be detected.

In the above embodiment, in which the operating body 1 is an automobile, the acceleration sensor 6 attached to the knuckle 11 to detect the vertical acceleration was used to obtain monitoring signal data used for event detection and abnormality detection. In the present invention, acceleration sensors for detecting acceleration in the traveling direction, transversal direction, and other various directions of the automobile can be used in addition to the sensors for detecting vertical acceleration. The present invention is not limited to uni-directional acceleration sensors; acceleration sensors in a plurality of directions may be used in combination. If, for example, sensors for detecting vertical direction acceleration, acceleration in the traveling direction, and acceleration in the transversal direction are attached at a single portion, the acceleration at the portion can be handled as a three-dimensional vector, improving the precision of abnormality detection.

Although the acceleration sensor 6 is attached to the knuckle 11 in the above embodiment, this is not a limitation. In addition to knuckle 11, non-rotating members disposed near the wheel 3 relative to the suspension 13, other than the wheel 3 and other rotating members, may be thought to cause the same motion. Accordingly, when the acceleration sensor 6 is attached to a non-rotating member near the wheel 3 relative to the suspension 13, the same signal as when the acceleration sensor 6 is attached to the knuckle 11 can be obtained. It is also possible to transmit by wireless the output signal of a physical quantity sensor disposed in the rotating wheel 3 to a receiver disposed on a non-rotating member.

If a physical quantity sensor is attached to another portion of the automobile, for example, around the engine 5, the present invention can be applied to detect an abnormality in the engine 5. If a physical quantity sensor is attached near a steering unit such as the steering wheel 4, the present invention can be applied to detect an abnormality in the steering unit.

Although the acceleration sensor 6 is attached to the knuckle 11 in the above embodiment, as described above, the acceleration sensor 6 may be attached to the body 2 supported on the top of the suspension 13. Since the entire automobile interior moves together with the body 2, if an acceleration sensor is attached at a portion on the body 2, the sensor detects acceleration exerted on the entire automobile interior, enabling data correlated to the behavior of the automobile interior to be collected. However, vibration generated below the suspension 13 is absorbed by the suspension 13, and the acceleration sensor attached to the body 2 has weak sensitivity to the vibration of the wheel 3. Accordingly, the acceleration sensor 6 can be advantageously attached to the knuckle 11, which supports the lower part of the suspension 13, to detect an abnormality in members around the wheel.

Although the acceleration sensors have been used to detect monitoring signals in the above embodiment, the present invention can use: vibration sensors; acoustic sensors; angular velocity sensors; distortion sensors for detecting distortion in members; automobile velocity sensors; wheel rotation sensors; temperature sensors; and other physical quantity sensors. These physical quantity sensors are preferably disposed so that their output signals change in response to an abnormality. These physical quantity sensors are preferably used alone or in combination. It can be expected that as the number of physical quantity sensors is increased and the number of physical quantity sensor types are increased, abnormality detection precision is increased, so the number of physical quantity sensors and their types should be determined with cost effectiveness taken into consideration. The physical quantity sensors can be used not only for abnormality detection but also for, e.g., control of automobile motion, enabling costs to be reduced.

As an example for using data in a period between events of the same type, the immediately-after-start event and passing-over-step event will be described next with reference to Table 4 and the processing flow in FIG. 8. In the state of immediately after start (the state is identified by the symbol P, see Table 2), when the engine is started by event e4, data of event e1, which is a previous event, is used together to increase the amount of data and thereby increase detection precision. Similarly, passing-over-step events e3 and e5 are present before and after engine stop/start event e4. In abnormality detection in the left turn state (symbol A, see Table 2) and right turn state (symbol B, see Table 2), all data in the appropriate state between events e3 and e5 is used to increase the amount of data and thereby increase detection precision.

Although the operating body 1 is an automobile in the above embodiment, the present invention can also be applied to a twisting apparatus, extruding apparatus, and rolling apparatus. An abnormality is effectively detected according to the present invention while these manufacturing apparatuses are operating.

An abnormality in a twisting apparatus for twisting electrical wires and the like includes overlapped wires to be twisted, breaks in wires, and changes in size. Events include a change in twisting speed, material exchange, and start. Manipulation states and operation states include a pitch setting and a feed rate level. Control signals and output signals of physical quantity sensors such as tension sensors for central materials and fed materials, feed rate sensors, and temperature sensors are preferably used to obtain data for event detection and abnormality detection.

An abnormality in an extruding apparatus includes increased dispersions in sizes of extruded products, increased dispersions in material density, and clogging. Events include a change in extruding speed, material exchange, and start. Manipulation states and operation states include an extruding speed level, an extruding pressure level, and the type of material used. Control signals and output signals of physical quantity sensors such as extrusion speed sensors, pressure sensors, and temperature sensors are preferably used to obtain data for event detection and abnormality detection.

An abnormality in a rolling apparatus includes increased dispersions in thicknesses of rolled products and increased dispersions in strength. Events include a change in feed rate, material exchange, and start. Manipulation states and operation states include a feed rate level and a temperature level. Control signals and output signals of physical quantity sensors such as feed rate sensors and temperature sensors are preferably used to obtain data for event detection and abnormality detection.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A method of detecting an abnormality in an operating body, comprising steps of:
continuously collecting data about the operating body;
detecting events for the operating body;
extracting part of the data as target data, the part of the data being collected in a predetermined period delimited by times at which the events are detected;
preparing comparison data in advance for abnormality detection;
comparing the target data with the comparison data to obtain a comparison result; and
detecting an abnormality in the operating body from the comparison result.

2. The method according to claim 1, wherein:
at least one of an output signal of a physical quantity sensor and a control signal for controlling the operating body is collected as the data.

3. The method according to claim 1, wherein:
a plurality of types of events are detected; and the period is delimited by times at which two events of the same type are detected.

4. The method according to claim 1, wherein:
the events are detected from the data.

5. The method according to claim 1, further comprising the steps of:
collecting a plurality of types of data;
determining a state of the operating body as a plurality of state types according to at least one type of data; and
detecting an abnormality for each determined state type.

6. The method according to claim 1, further comprising the steps of:
collecting a plurality of types of data;
determining a state of the operating body as a plurality of state types according to at least one type of data;
delimiting a partial period by predetermined state types in the predetermined period delimited by times at which the events are detected; and
extracting part of the data as target data, the part of the data being collected as target data in the predetermined period.

7. The method according to claim 1, further comprising the steps of:
collecting data on an output signal of a physical quantity sensor and data on a control signal for controlling the operating body; and
performing signal processing on the data of the output signal, the signal processing for the output signal being concurrent with collecting the data on the control signal or being delayed by a predetermined time with respect to collecting the data on the control signal.

8. The method according to claim 1, further comprising the steps of:
collecting data on an output signal of a physical quantity sensor and data on a control signal for controlling the operating body;
predicting data on the output signal from the data on the control signal; and
using the predicted data as the comparison data.

9. The method according to claim 1, further comprising the steps of:
processing the target data; and
comparing the target data, which is processed, and the comparison data, which is processed in advance, to detect an abnormality.

10. The method according to claim 1, further comprising the steps of:
detecting, from a component having periodicity in the target data, an abnormality with a correlation with the periodicity; and
detecting, from another component not having periodicity in the above target data, an abnormality without the correlation with the periodicity.

11. The method according to claim 1, further comprising the steps of:
detecting an abnormality in a rotating member from a component, in the target data, that is synchronous with rotation of the rotating member, the rotating member being included in the operating body; and
detecting an abnormality in a non-rotating member from another component, in the target data, that is not synchronous with the rotation of the rotating member, the non-rotating member being included in the operating body.

12. The method according to claim 1, wherein:
the operating body is an automobile.

13. An operating body abnormality detection system comprising:
an operating body;
a data collecting part for continuously collecting data from the operating body;
an event detecting part for detecting events of the operating body;
a target data extracting part for extracting a part of the data, which is continuously collected, as target data, the part of the data being collected in a predetermined period delimited by the events;
a comparison database for storing in advance comparison data used for abnormality detection; and
a comparison and calculation part for comparing the target data with the comparison data to obtain a comparison result and detecting an abnormality in the operating body according to the comparison result.
